(19) United States
(12) Patent Application Publication
(10) Pub. No.: US 2011/0187921 A1
(43) Pub. Date: Aug. 4, 2011

(54) CAMERA MODULE AND ELECTRONIC DEVICE UTILIZING THE SAME

(75) Inventors: SSU-HAN HUANG, Tu-Cheng (TW); TAI-HSU CHOU, Tu-Cheng (TW)

(73) Assignee: HON HAI PRECISION INDUSTRY CO., LTD., Tu-Cheng (TW)

(21) Appl. No.: 12/940,028

(22) Filed: Nov. 4, 2010

(30) Foreign Application Priority Data
Jan. 29, 2010 (TW) 99102548

(51) Int. Cl. H04N 5/225

(52) U.S. Cl. 348/374; 348/E05.024

(57) ABSTRACT

A camera module includes a substrate, a lens module, a driver circuit and a electromagnetic interference shield. The substrate includes a first surface and a second surface opposite to the first surface, and the lens module is positioned on the first surface of the substrate. The driver circuit is positioned on the first surface of the substrate, and is electrically connected to the lens module. The electromagnetic interference shield is positioned on the first surface of the substrate and covers the driver circuit. The electromagnetic interference shield includes a case and pins. The case covers the driver circuit. The pins extend from the case and pass through the substrate to secure the electromagnetic interference shield on the substrate.

### BACKGROUND

1. Technical Field

The present disclosure is related to camera modules, especially to a camera module with a shield blocking electrical magnetic interference.

2. Description of Related Art

A driver circuit in a conventional camera module of an electronic device (such as a laptop computer, a cell phone, or other device) is often interfered with by electromagnetic interference (EMI) from other components of the electronic device, which results in inferior image quality. A typical EMI shield used in a camera module is shaped as a metallic cover and attached on a substrate by adhesive on the edges of the metallic cover. However, the adhesive easily separates.

Therefore, a new camera module overcoming the limitations is desired.

### BRIEF DESCRIPTION OF THE DRAWINGS

FIG. 1 is a perspective view of one embodiment of a camera module, the camera module comprising an EMI shield.

FIG. 2 is another perspective view of the camera module of FIG. 1, viewed from the bottom of the camera module.

FIG. 3 is an exploded view of FIG. 1.

FIG. 4 is a perspective view of the EMI shield of the camera module of FIG. 1, the EMI shield comprising pins.

FIG. 5 is another perspective view of the EMI shield of the camera module of FIG. 1, wherein the pins are bent.

FIG. 6 is an illustrative view of one embodiment of an electronic device utilizing a camera module of FIG. 1.

### DETAILED DESCRIPTION

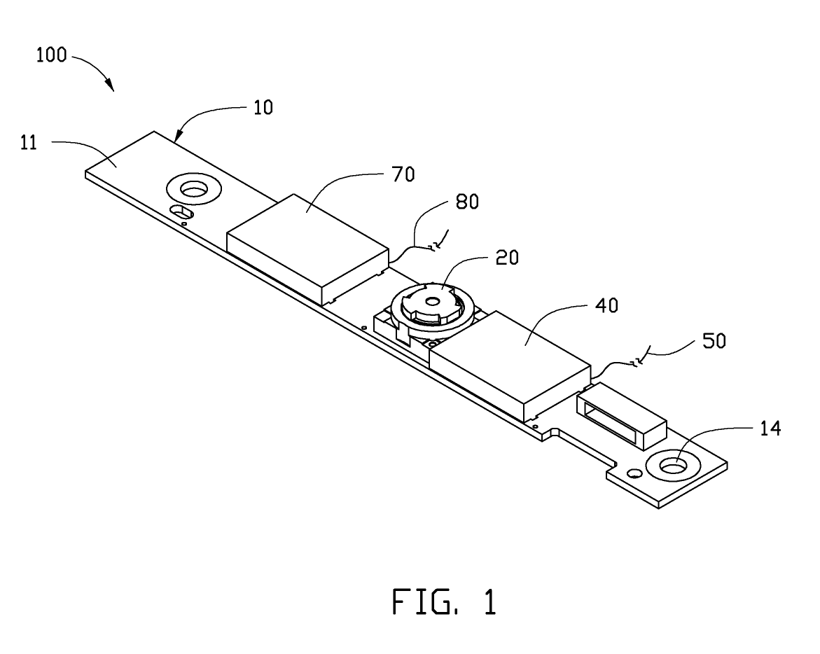

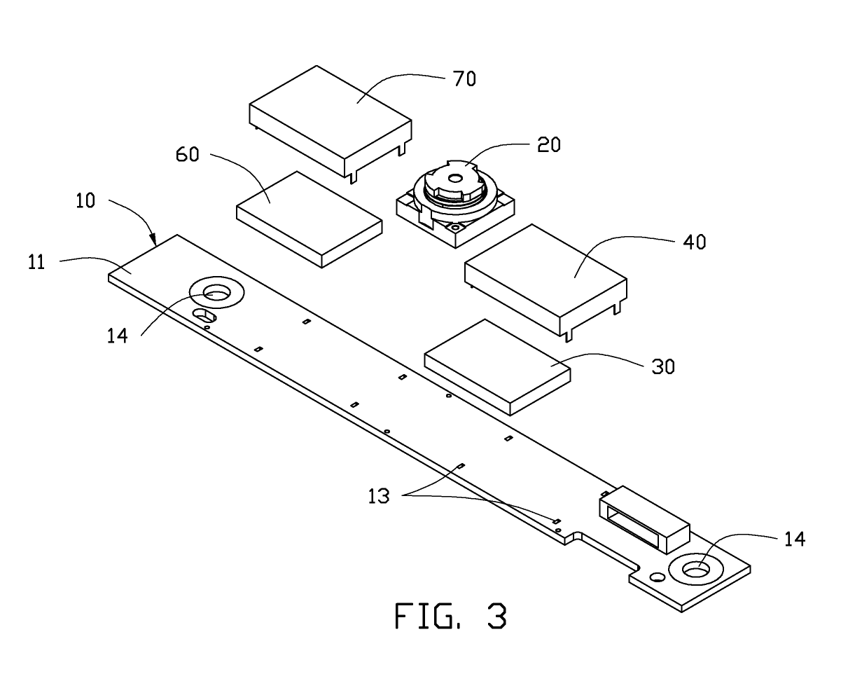

Referring to FIGS. 1 to 3, one embodiment of a camera module 100 comprises a substrate 10, a lens module 20, a first driver circuit 30 and a first EMI shield 40. The substrate 10 comprises a first surface 11 and a second surface 12 opposite to the first surface 11. Four first through holes 13 and two second through holes 14 are defined on the first surface 11, and pass through to the second surface 12. The first through holes 13 are configured for assembling the first EMI shield 40, and the second through holes 14 are configured for attaching the camera module 100 to an electronic device by screw bolts or screws.

The lens module 20 is positioned on the first surface 11 of the substrate 10. The first driver circuit 30 is positioned on the first surface 11 of the substrate 10, and is adjacent to the lens module 20. The first driver circuit 30 is electrically connected to the lens module 20 to drive the lens module 20 and enable the camera module 100 work.

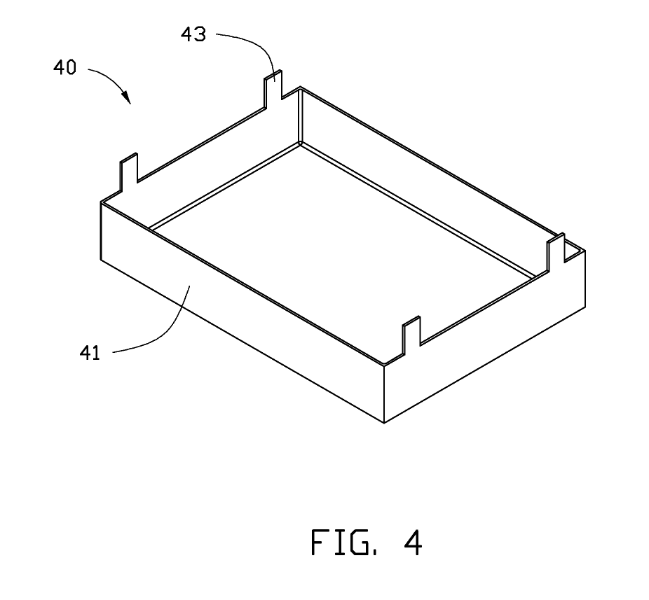

Please refer to FIG. 4, the first EMI shield 40 comprises a case 41 and four pins extended from edges of the case 41, which correspond to the first through holes 13 of the substrate 10. The case 41 of the first EMI shield 40 is shaped as a rectangle, and the pins 43 are shaped as plates. The first EMI shield 40 is made of metal or metal alloy.

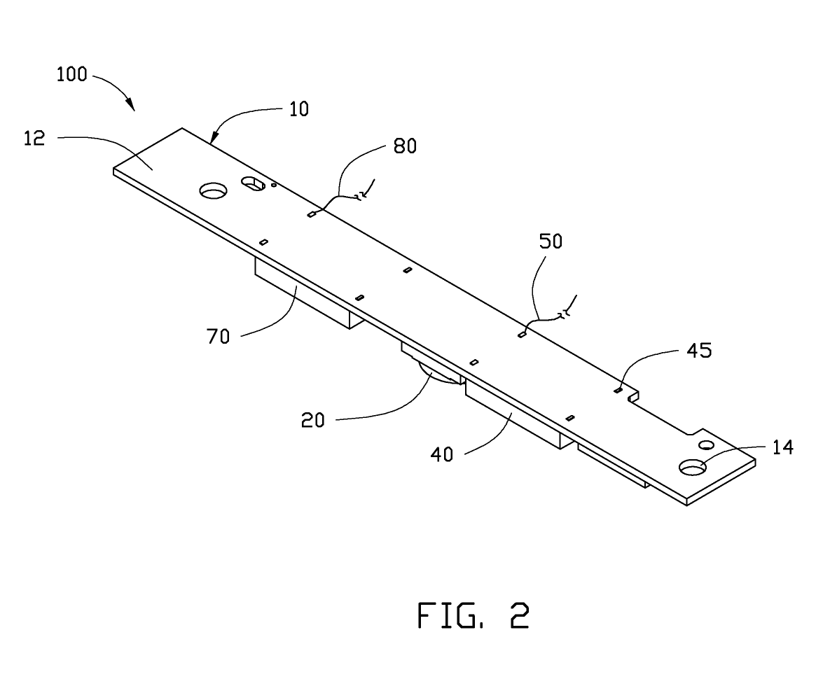

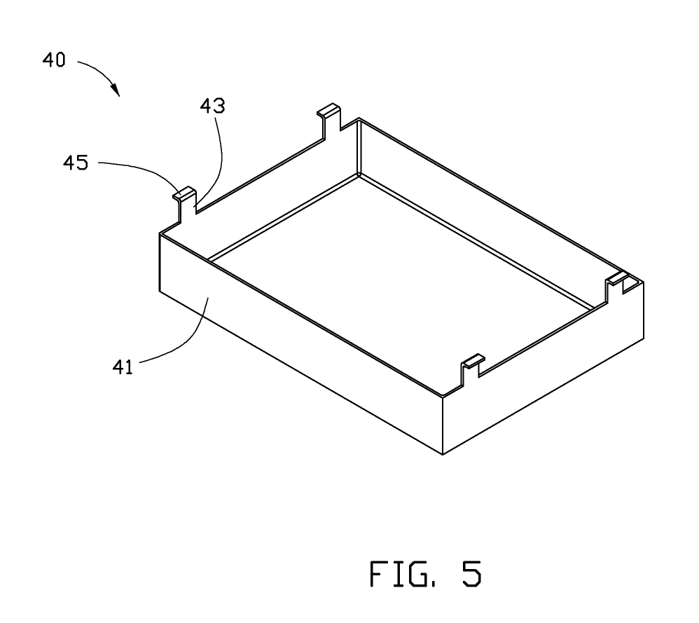

As shown in FIGS. 2 and 5, a distal end of each pin 43 extends through the first through hole 13 and is bent to form a fastener 45. The fastener 45 contacts the second surface 12 and fastens the first EMI shield 40 to the substrate 10. To ensure that the first EMI shield 40 is fastened to the substrate 10 tightly, the fastener 45 is fastened to the substrate 10 with conductive silver gel. The fastener 45 is further connected to a first grounded line 50, to enable electro-static discharge (ESD).

As shown in FIGS. 1 to 3, a second driver circuit 60 is positioned on the first surface 11 of the substrate 10, and is configured for driving other components. A second EMI shield 70 covers the second driver circuit 60 to shield electromagnetic waves, and is also connected to a second grounded line 80.

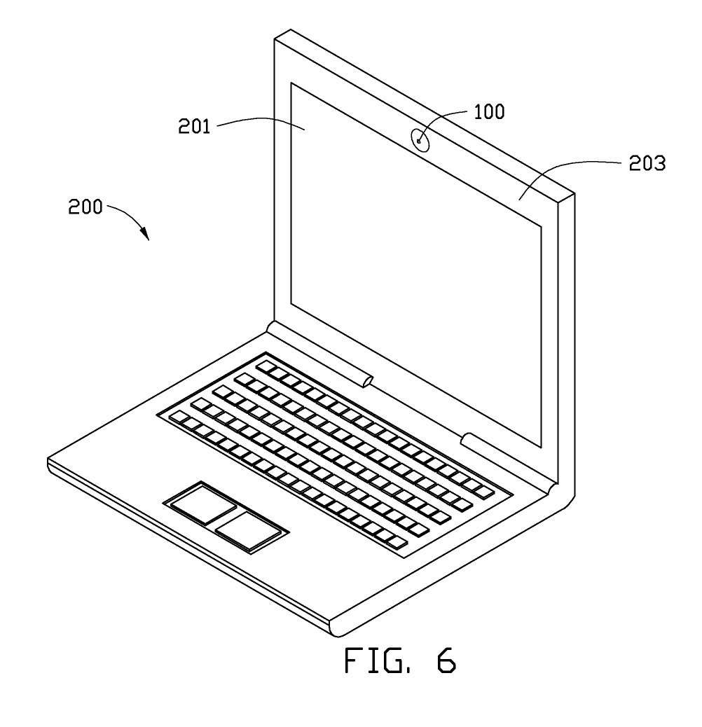

As shown in FIG. 6, a camera module 100 is assembled in an electronic device 200, here showing a laptop as an example. The camera module 100 is assembled to the top of the screen 201 of the laptop 200, and is received in the bezel thereof

The camera module 100 of the present disclosure is stably fixed to an electronic device and is not easily dislodged, while ensuring that the lens module in the camera module is protected from electromagnetic interference (EMI) and electro-static discharge (ESD). Such EMI test and ESD prevention test are easily applied on the electronic device 200 and the yield rate is increased.

While the disclosure has been described by way of example and in terms of the embodiments, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A camera module, comprising:
a substrate comprising a first surface and a second surface positioned opposite to the first surface, the substrate defining a plurality of through holes extending from the first surface to the second surface;
a lens module positioned on the first surface of the substrate;
a driver circuit positioned on the first surface of the substrate and electrically connected to the lens module; and
an electromagnetic interference (EMI) shield positioned on the first surface of the substrate and covering the driver circuit, wherein the EMI shield comprises a case covering the driver circuit, and a plurality of pins extending from the case and corresponding to the through holes, and the pins pass through the through holes and secure the EMI shield on the substrate.

2. The camera module as claimed in claim 1, wherein a distal end of each pin passes through a correspond through hole and is bent to form a fastener, and the fastener contacts the second surface and secure the EMI shield on the substrate.

3. The camera module as claimed in claim 2, wherein the fastener secures the EMI shield on the substrate by conductive silver gel.

4. The camera module as claimed in claim 2, wherein the fastener is grounded.

5. The camera module as claimed in claim 1, wherein the EMI shield is made of metal or metal alloy.

6. An electronic device comprising a camera module, the camera module comprising:
a substrate comprising a first surface and a second surface positioned opposite to the first surface;
a lens module positioned on the first surface of the substrate;
a driver circuit positioned on the first surface of the substrate and is electrically connected to the lens module; and
an EMI shield positioned on the first surface of the substrate and covering the driver circuit.

7. The electronic device as claimed in claim 6, wherein the substrate defines a plurality of through holes; the EMI shield comprises a case covering the driver circuit, and a plurality of pins extending from the case and corresponding to the through holes, and the pins pass through the through holes and are bent to contact the second surface.

8. A camera module, comprising:
a substrate;
a lens module positioned on the substrate;
a driver circuit positioned on the substrate and electrically connected to the lens module; and
an EMI shield positioned on the substrate and covering the driver circuit, wherein the EMI shield comprises a case covering the driver circuit, and a plurality of pins extending from the case, and the pins pass through the substrate and secure the EMI shield on the substrate.
